(19) United States
(12) Patent Application Publication
(10) Pub. No.: US 2017/0167780 A1
(43) Pub. Date: Jun. 15, 2017

(54) REFRIGERATOR

(71) Applicant: Samsung Electronics Co., Ltd, Gyeonggi-do (KR)

(72) Inventors: Jin Jeong, Gyeonggi-do (KR); Jeong Hyun Lee, Gyeonggi-do (KR); Yoon Young Kim, Gyeonggi-do (KR); Jae-Min Lee, Gyeonggi-do (KR)

(21) Appl. No.: 15/374,836

(22) Filed: Dec. 9, 2016

(30) Foreign Application Priority Data
Dec. 11, 2015 (KR) 10-2015-0177141

(51) Int. Cl. F25D 23/06; B67D 1/00; F25C 5/00; F25D 23/02; F25D 11/02; F25D 23/12

(52) U.S. Cl. CPC F25D 23/062; F25D 11/02; F25D 23/126; F25C 5/005; F25D 23/028; B67D 1/0014; F25D 2323/121; F25D 2323/024; F25D 2700/04; F25D 2323/023; F25D 2500/02

(57) ABSTRACT

Disclosed herein is a refrigerator. The refrigerator includes a body; a fresh food compartment provided in an upper portion of the body, a freezer compartment provided in a lower portion of the body, an upper door configured to open or close the fresh food compartment, a lower door configured to open or close the freezer compartment, a first dispenser provided in the upper door and configured to provide water, and a second dispenser provided in the lower door and configured to provide ice.

### CROSS-REFERENCE TO RELATED APPLICATION(S) AND CLAIM OF PRIORITY

This application claims the benefit of Korean Patent Application No. 10-2015-0177141, filed on Dec. 11, 2015 in the Korean Intellectual Property Office, the disclosure of which is incorporated herein by reference.

### TECHNICAL FIELD

Embodiments of the present disclosure relate to a Bottom Mounted Freezer (BMF) type refrigerator in which a freezer compartment is provided in a lower portion and a fresh food compartment is provided in an upper portion.

### BACKGROUND

A refrigerator is an appliance to keep food fresh by including a body having a storage compartment, and a cold air supply system to supply cold air to the storage compartment. The storage compartment includes a fresh food compartment kept at a temperature of approximately 0° C.˜5° C., to store food in a refrigerated state, and a freezer compartment kept at a temperature of approximately −30° C.˜0° C., to store food in a frozen state.

The refrigerator may be classified by a position of the fresh food compartment and the freezer compartment. Particularly, the refrigerator may be classified into a Bottom Mounted Freezer (BMF) type refrigerator in which a fresh food compartment is formed in the upper portion and a freezer compartment is formed in the lower portion, a Top Mounted Freezer (TMF) type refrigerator in which a freezer compartment is formed in the upper portion and a fresh food compartment is formed in the lower portion, and a Side by Side (SBS) type refrigerator in which a freezer compartment and a fresh food compartment are formed side by side in the left and right direction. Further, the refrigerator may be classified by the number of the door, and thus the refrigerator may be classified into two-door type refrigerator, three-door type refrigerator, and four-door type refrigerator.

When an ice maker and a dispenser are provided in the BMF type refrigerator, an ice making compartment may be typically provided in an upper corner of the fresh food compartment while being separated from the fresh food compartment, and then the ice maker may be disposed in the ice making compartment. Due to such the arrangement, the shape of the fresh food compartment does not have a regular hexahedron and thus the utilization of the space is reduced.

In addition, the dispenser is disposed in the door to provide ice generated in the ice maker, and thus a passage configured to guide the ice from the ice making compartment to an outlet is provided in a rear surface of the door. Therefore, on the rear surface of the door, a space for installing a door guard is reduced.

### SUMMARY

Therefore, it is an aspect of the present disclosure to provide a Bottom Mounted Freezer (BMF) type refrigerator having a storage space to store food and a new platform having an improved utilization.

It is another aspect of the present disclosure to provide a BMF type refrigerator having increased storage space in a fresh food compartment and having an improved utilization thereof.

It is another aspect of the present disclosure to provide a BMF type refrigerator capable of allowing a user to confirm, and insert and withdraw food placed inside of a fresh food compartment without opening all of a fresh food compartment door.

It is another aspect of the present disclosure to provide a BMF type refrigerator capable of closing a dispenser from the outside when the dispenser is not use.

Additional aspects of the disclosure will be set forth in part in the description which follows and, in part, will be obvious from the description, or may be learned by practice of the disclosure.

In accordance with one aspect of the present disclosure, a refrigerator includes a body, a fresh food compartment provided in an upper portion of the body, a freezer compartment provided in a lower portion of the body, an upper door configured to open or close the fresh food compartment, a lower door configured to open or close the freezer compartment, a first dispenser provided in the upper door and configured to provide water, and a second dispenser provided in the lower door and configured to provide ice.

The refrigerator may further include an ice making unit connected to the second dispenser to generate ice, wherein the ice making unit may be disposed inside of the freezer compartment.

The refrigerator may further include a filter disposed inside of the body to purify water supplied from a water source, and a water supply valve configured to selectively supply water, which is purified by passing through the filter, to one of the first dispenser, the second dispenser and the ice making unit.

The refrigerator may further include a storage tank provided on a flow path in which water, which is purified by passing through the filter, is supplied to the first dispenser and the second dispenser, and provided on the flow path between the filter and the water supply valve.

A flow path connecting the ice making compartment and the water supply valve may be disposed inside of the body.

A flow path connecting the water supply valve and the first dispenser may be configured to pass through an upper hinge corresponding to a rotational axis of the upper door, and a flow path connecting the water supply valve and the second dispenser may be configured to pass through a lower hinge corresponding to a rotational axis of the lower door.

The lower door may include a shutter configured to selectively expose the second dispenser.

The lower door may include a detection sensor disposed adjacent to the second dispenser to detect a command of a user related to whether to open or close the shutter, wherein the shutter may be configured to be selectively opened or closed by the command detected by the detection sensor.

The detection sensor may include at least one of a proximity sensor and a voice recognition sensor.

One end portion of the shutter may be hinge-coupled to the lower door so that the shutter is opened or closed while being rotatably moved with respect to the lower door.

The shutter may be configured to be opened or closed in a sliding manner with respect to the lower door.

The upper door may include a first upper door and a second upper door, a first auxiliary door configured to be rotated independently from the first upper door is provided between the first upper door and the fresh food compartment and a second auxiliary door configured to be rotated independently from the second upper door is provided between the second upper door and the fresh food compartment.

At least one of the first auxiliary door and the second auxiliary door may include a door guard and an opening configured to allow a user to access to the fresh food compartment when the upper door is opened.

The door guard may include a transparent material to confirm food stored in the fresh food compartment.

The second dispenser may be configured to provide ice and water.

In accordance with another aspect of the present invention, a refrigerator may include a body, a fresh food compartment provided in an upper portion of the body, an ice making compartment provided in a lower side of the fresh food compartment, a freezer compartment provided in a lower side of the ice making compartment, an upper door configured to open or close the fresh food compartment, an ice making compartment door configured to open or close the ice making compartment, a lower door configured to open or close the freezer compartment, a first dispenser provided in the upper door and configured to provide water, and a second dispenser provided in the ice making compartment door and configured to provide ice.

An ice maker configured to generate ice and an ice bucket configured to store the ice generated by the ice maker may be provided inside of the ice making compartment.

The ice making compartment door may include a shutter configured to selectively expose the second dispenser.

In accordance with still another aspect of the present invention, a refrigerator may include a body, a fresh food compartment provided in an upper portion of the body, a freezer compartment provided in a lower portion of the body, an upper door configured to open or close the fresh food compartment and arranged side by side in the left and right direction of the fresh food compartment, a lower door configured to open or close the freezer compartment, a first dispenser provided in the upper door and configured to provide water, and an auxiliary door provided between the upper door and the fresh food compartment and configured to be rotated independently from the upper door.

The auxiliary door may include a plurality of door guards configured by comprising a transparent material, wherein the plurality of door guards may be apart from each other to communicate the fresh food compartment with the outside when the upper door is opened.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a front side of a refrigerator in accordance with one embodiment of the present disclosure.

FIG. 2 is a view illustrating a state in which an upper door and of the refrigerator shown in FIG. 1 is opened.

FIG. 3 is a view illustrating a state in which an upper door and, a lower door and, and an auxiliary door and of the refrigerator shown in FIG. 1 are opened.

FIG. 4 is a cross-sectional view illustrating the refrigerator shown in FIG. 1.

FIG. 5 is a view illustrating another example of the shutter shown in FIG. 4

FIG. 6 is a view illustrating another example of the refrigerator shown in FIG. 1.

FIG. 7 is a view illustrating a state in which an upper door and of a refrigerator shown in FIG. 6 is opened.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Throughout the disclosure, like reference numerals refer to like parts throughout the various figures and embodiments of the present disclosure.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, third, etc., may be used herein to describe various elements, but elements are not limited by these terms. These terms are only used to distinguish one element from another element. For example, without departing from the scope of the present disclosure, a first element may be termed as a second element, and a second element may be termed as a first element. The term of “and/or” includes a plurality of combinations of relevant items or any one item among a plurality of relevant items.

In the following detailed description, the terms of “front end”, “rear end”, “upper portion”, “lower portion”, “upper end”, “lower end” and the like may be defined by the drawings, but the shape and the location of the component is not limited by the term.

Hereinafter embodiments of the present disclosure will be described with reference to drawings.

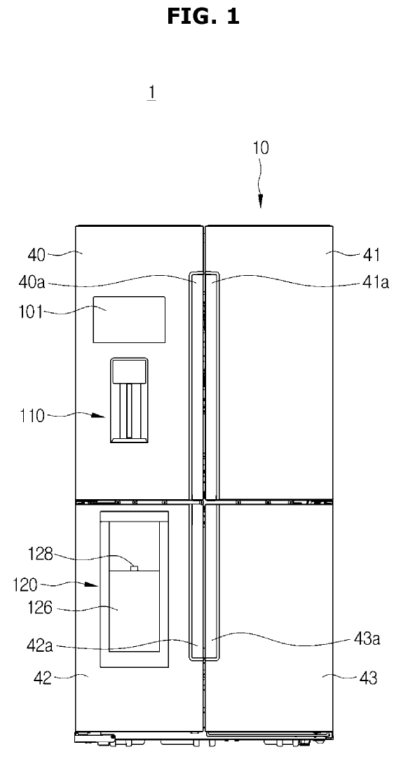

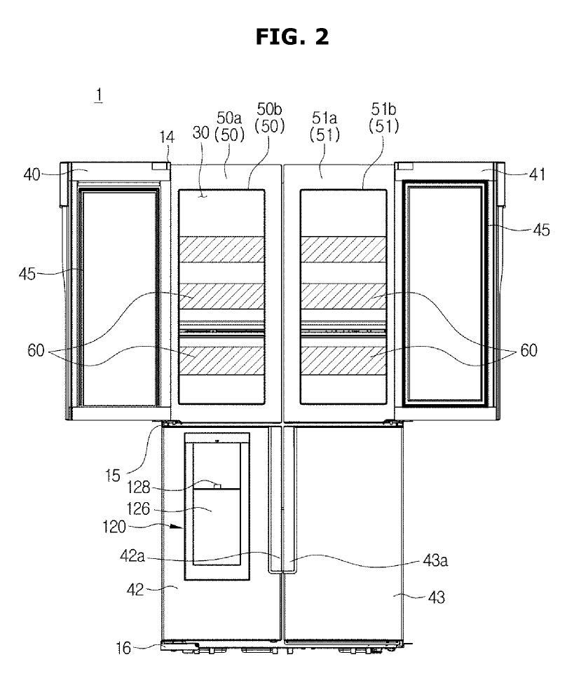

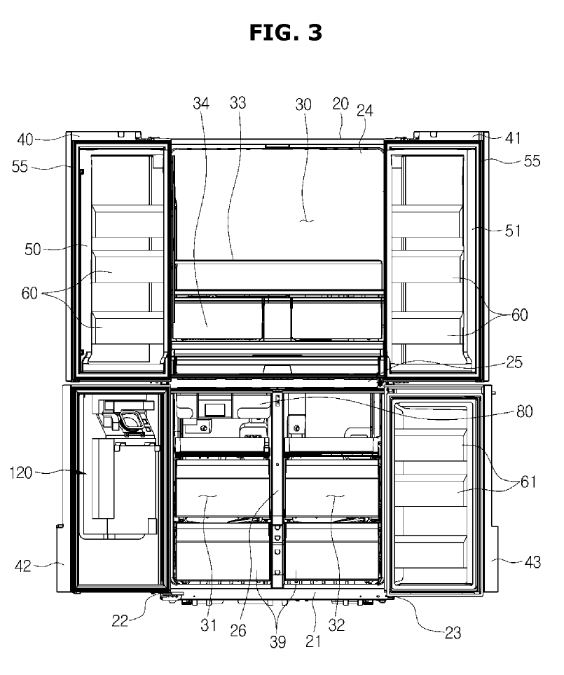

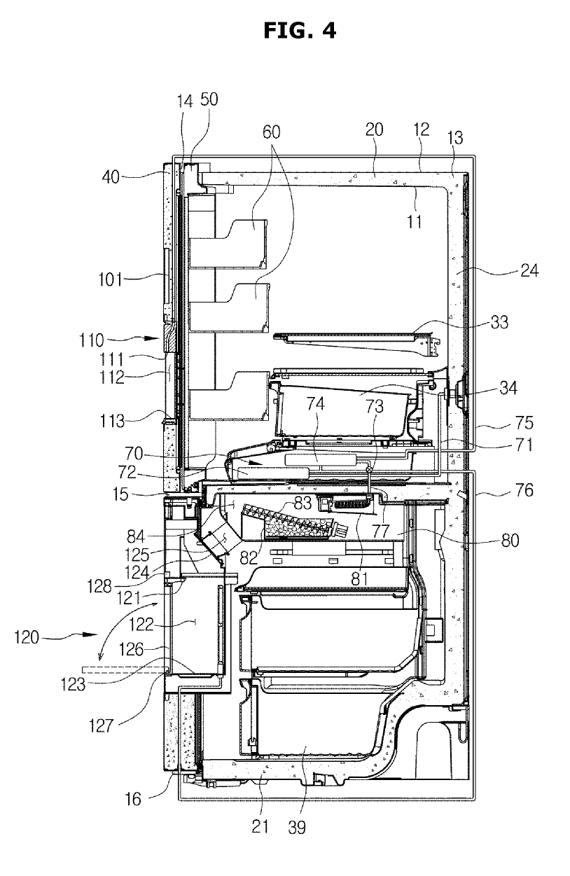

FIG. 1 is a view illustrating a front side of a refrigerator 1 in accordance with one embodiment of the present disclosure. FIG. 2 is a view illustrating a state in which an upper door 40 and 41 of the refrigerator 1 shown in FIG. 1 is opened. FIG. 3 is a view illustrating a state in which an upper door 40 and 41, a lower door 42 and 43, and an auxiliary door 50 and 51 of the refrigerator 1 shown in FIG. 1 are opened. FIG. 4 is a cross-sectional view illustrating the refrigerator 1 shown in FIG. 1.

Referring to FIGS. 1 to 4, the refrigerator 1 may include a body 10, a storage compartment 30, 31 and 32 formed in the inside of the body 10 to store food, a cold air supply system (not shown) to supply cold air to the storage compartment 30, 31, and 32, and a door 40, 41, 42 and 43 to open and close the storage compartment 30, 31, and 32.

The storage compartment 30, 31, and 32 may include an upper compartment 30 and a lower compartment 31 and 32.

The upper compartment 30 may correspond to a fresh food compartment 30 configured to store food in a refrigerated state. The fresh food compartment 30 may be kept at a temperature of approximately 0° C.˜5° C. to store food in a refrigerated state.

The lower compartment 31 and 32 may have a first freezer compartment 31 and a second freezer compartment 32 to store food in a frozen state. The first freezer compartment 31 and the second freezer compartment 32 may be kept at a temperature of approximately −30° C.˜0° C., to store food in a frozen state.

The body 10 may have an approximately box shape, and a front surface thereof may be opened. The body 10 may include an inner case 11, an outer case 12 coupled to the outside of the inner case 11 and an insulation 13 provided between the inner case 11 and the outer case 12.

The inner case 11 may be formed of resin material in an injection molding method. In the inside of the inner case 11, the fresh food compartment 30, the first freezer compartment 31, and the second freezer compartment 32 may be formed. That is, the inner case 11 may limit a range of each storage compartment.

The outer case 12 may be formed of metal material having a high strength and aesthetic sense

The insulation 13 may be provided between the inner case 11 and the outer case 12. The insulation 13 may include urethane foam insulation and as needed, the insulation 13 may include vacuum insulation panel. The urethane foam insulation may be formed such that, after the inner case 11 and the outer case 12 are coupled to each other, a space therebetween is filled with urethane foam, in which foaming agent and urethane are mixed, and then the urethane foam is foamed. The urethane foam may have a strong adhesive force so that the coupling force between the inner case 11 and the outer case 12 may be improved and it may have a sufficient intensity when the foaming is completed.

An upper wall 20, a lower wall 21, a left wall 22, a right wall 23, a rear wall 24, a division wall 25, and a middle wall 26 described later may be integrally formed with each other since the urethane foam is filled and foamed between the inner case 11 and the outer case 12.

In other words, the body 10 may have the upper wall 20, the lower wall 21, the left wall 22, the right wall 23, the rear wall 24, the division wall 25, and the middle wall 26.

The division wall 25 may divide an inner space of the body 10 into an upper portion and a lower portion. That is, the division wall 25 may divide the inner space of the body 10 into the fresh food compartment 30 and the freezer compartment 31 and 32. The division wall 25 may be approximately horizontally extended from the left wall 22 to the right wall 23, and may include the inner case 11 and the insulation 13.

The middle wall 26 may divide the freezer compartment 31 and 32 into the left side and the right side. That is, the middle wall 26 may divide the freezer compartment 31 and 32 into the first freezer compartment 31 and the second freezer compartment 32. The middle wall 26 may be approximately vertically extended from the division wall 25 to the lower wall 21, and may include the inner case 11 and the insulation 13.

A shelf 33 on which food are placed, an airtight container 34 airtightly storing food and a drawer (not shown) slidable back and forth may be provided in the each storage compartment 30, 31, and 32.

The door 40, 41, 42 and 43 to open and close the storage compartment 30, 31, and 32 may be configured with four doors; a first upper door 40, a second upper door 41, a first lower door 42, and a second lower door 43. Each of the doors 40, 41, 42 and 43 may be rotatably coupled to the body 10.

The first upper door 40 and the second upper door 41 may be rotatably coupled to the body 10 by an upper hinge 14 and a middle hinge 15, respectively. The upper hinge 14 may be coupled to the upper wall 20 to support the first upper door 40 and the second upper door 41. The middle hinge 15 may be coupled to the division wall 25 to support the first upper door 40 and the second upper door 41. The first upper door 40 and the second upper door 41 may be opened or closed while being rotated in a different direction that is opposite to each other. On the inside of the first upper door 40 and the second upper door 41, a handle 40a and 41a may be provided.

A first sealing member 45 may be provided on a rear surface of the upper door 40 and 41 to prevent cold air from being leaked between the upper door 40 and 41 and the body 10 in a state in which of the upper door 40 and 41 is closed.

The first sealing member 45 may be formed of rubber material. The sealing member 45 may be formed along an edge of the rear surface of the upper door 40 and 41. The first sealing member 45 may be formed in an approximately closed loop in the shape of square. When the upper door 40 and 41 is closed, the first sealing member 45 may adhere to the upper auxiliary door 50 and 51 described later.

The first lower door 42 and the second lower door 43 may be rotatably coupled to the body 10 by the middle hinge 15 and a lower hinge 16, respectively. The first lower door 42 and the second lower door 43 may be opened or closed while being rotated in a different direction that is opposite to each other. On the inside of the first lower door 42 and the second lower door 43, a handle 42a and 43a may be provided

The first lower door 42 may open and close the first freezer compartment 31. The second lower door 43 may open and close the second freezer compartment 32. A door guard 61 may be provided in the first lower door 42 and/or the second lower door 43.

The cold air supply system (not shown) may generate cold air using a refrigeration cycle. The cold air supply system may include a compressor (not shown), a condenser (not shown), an expansion device (not shown), an evaporator (not shown), a blowing fan (not shown) and at least one refrigerant circuit in which refrigerant is circulated.

There may be no limitation in the number of the compressor, the condenser, the expansion device, the evaporator and the blowing fan, and the shape of the refrigerant circuit.

For example, the cold air supply system may have a plurality of refrigerant circuit; a first refrigerant circuit and a second refrigerant circuit. In the first refrigerant circuit, a first compressor, a first evaporator, and a first blowing fan may be provided. In the second refrigerant circuit, a second compressor, a second evaporator, a third evaporator, a second blowing fan and a third blowing fan may be provided.

The first blowing fan may supply cold air generated in the first evaporator to the fresh food compartment 30. The second blowing fan may supply cold air generated in the second evaporator to the first freezer compartment 31. The third blowing fan may supply cold air generated in the third evaporator to the second freezer compartment 32.

As a result, the cold air supply system may independently supply cold air to three parts and thus the fresh food compartment 30 corresponding to the upper compartment; the first freezer compartment 31 corresponding to the left storage of the lower compartment; and the second freezer compartment 32 corresponding to the right storage of the lower compartment may be independently cooled.

However, as mentioned above, the cold air supply system may be an example, and the scope of the present disclosure may be not limited to a cold air supply system configured to supply cold air to each of storages.

Referring to FIG. 2, the refrigerator 1 may include the auxiliary door 50 and 51 provided between the body 10 and the upper door 40 and 41. Particularly, the auxiliary door 50 and 51 may be provided between the upper door 40 and 41 and the fresh food compartment 30. The auxiliary door 50 and 51 may include a first auxiliary door 50 and a second auxiliary door 51. The auxiliary door 50 and 51 may be rotatable separately from the upper door 40 and 41 with respect to the body 10.

The first auxiliary door 50 and the second auxiliary door 51 may be rotatably coupled to the body 10 by the upper hinge 14 and the middle hinge 15, respectively. That is, a rotational axis of the first auxiliary door 50 may be identical to a rotational axis of the first upper door 40 and a rotational axis of the second auxiliary door 51 may be identical to a rotational axis of the second upper door 41. Accordingly, the first auxiliary door 50 may be rotatable together with the first upper door 40 and the second auxiliary door 51 may be rotatable together with the second upper door 41. However, the configuration of the first auxiliary door 50 and the second auxiliary door 51 is not limited thereto and thus any configuration may be applied to the first auxiliary door 50 and the second auxiliary door 51 as long as capable of being separately rotatable from the first upper door 40 and the second upper door 41.

The auxiliary door 50 and 51 may include an auxiliary door case 50a and 51a provided along an edge of the auxiliary door 50 and 51, and an opening 50b and 51b configured to communicate the fresh food compartment 30 with the outside in a state in which the auxiliary door 50 and 51 is closed.

An appearance of the auxiliary door case 50a and 51a may have a similar shape with the upper door 40 and 41. That is, the appearance of the auxiliary door case 50a and 51a may be formed in an approximately square shape and particularly formed to have a frame shape since the opening 50b and 51b is provided therein.

In the auxiliary door case 50a and 51a, a door guard 60 may be provided. Food having a relatively small size and short height or food that is needed to be frequently inserted and withdrawn may be stored on the door guard 60. The door guard 60 may be provided in plural and a plurality of door guards 60 may be arranged in a row in an upper and lower direction of the auxiliary door case 50a and 51a. The plurality of door guards 60 may be apart from each other to communicate the fresh food compartment 30 with the outside when the upper door 40 and 41 is opened. The door guard 60 may be configured by including a transparent material so that a user confirms the inside of the fresh food compartment 30.

A second sealing member 55 may be provided on a rear surface of the auxiliary door case 50a and 51a to prevent cold air from being leaked between the auxiliary door 50 and 51 and the body 10 in a state in which the auxiliary door 50 and 51 is closed together with the upper door 40 and 41. The second sealing member 55 may be also formed of rubber material, like as the first sealing member 45. The second sealing member 55 may be formed along an edge of the rear surface of the auxiliary door case 50a and 51a. The second sealing member 55 may be formed in an approximately closed loop in the shape of square. When the auxiliary door 50 and 51 is closed, the second sealing member 55 may adhere to the upper wall 20, the left wall 22, the right wall 23, and the division wall 25 of the body 10.

Due to the configuration, a user may insert and withdraw food stored in the door guard 60 by accessing to the door guard 60 via the opening 50b and 51b in a state in which only the upper door 40 and 41 is opened. In this time, the leakage of the cold air in the fresh food compartment 30 may be more restricted than a case in which the auxiliary door 50 and 51 is opened together with the upper door 40 and 41.

Further, as illustrated in FIG. 3, when the auxiliary door 50 and 51 is opened together with the upper door 40 and 41, the user may insert and withdraw food stored on the shelf 33 by accessing to the inside of the fresh food compartment 30. In this time, the user may also access to the door guard 60 to insert and withdraw food stored in the door guard 60.

The refrigerator 1 may include a water supply system 70. The water supply system 70 may be configured to supply water to a first dispenser 110, a second dispenser 120, and an ice making unit 80, which are described later, by receiving water from the external water source. The water supply system 70 may include a first water supply pipe 71, a filter 72, a water supply valve 73, a storage tank 74, a second water supply pipe 75, a third water supply pipe 76 and a fourth water supply pipe 77.

One end of the first water supply pipe 71 may be connected to the external water source and the other end of the first water supply pipe 71 may be connected to the filter 72. Accordingly, the first water supply pipe 71 may guide water to the filter 72 so that water supplied from the outside is purified and then supplied.

The filter 72 may be configured to purify water supplied from the outside so that the purified water has a quality to allow the user to drink. Some of the water purified by the filter 72 may flow to the water supply valve 73 and then guided to the ice making unit 80 described later via the fourth water supply pipe 77, and the rest of the water purified by the filter 72 may be guided to the storage tank 74. In this time, the fourth water supply pipe 77 may be provided inside of the refrigerator 1 unlike the second water supply pipe 75 and the third water supply pipe 76.

The storage tank 74 may be provided on a flow path in which the water purified by passing through the filter 72 is supplied to the first dispenser 110 and the second dispenser 120, particularly provided on the flow path between the filter 72 and the water supply valve 73. Water stored in the storage tank 74 may be cooled while being stored in the storage tank 74. Accordingly, the refrigerator 1 may provide cold water via the first dispenser 110 and the second dispenser 120.

The water stored in the storage tank 74 may be divided by the water supply valve 73 and thus some of the water may be guided to the first dispenser 110 and the rest of the water may be guided to the second dispenser 120.

Particularly, some of the water passing through the water supply valve 73 may be guided to the first dispenser 110 through the second water supply pipe 75. The second water supply pipe 75 may be extended along the rear wall 24 and the upper wall 20 of the refrigerator 1 and then connected to the first dispenser 110 inside of the upper door 40 and 41 after passing through the upper hinge 14. According to the embodiment, since the first dispenser 110 is disposed in the first upper door 40, the second water supply pipe 75 may be provided inside of the first upper door 40.

The rest of the water passing through the water supply valve 73 may be guided to the second dispenser 120 through the third water supply pipe 76. The third water supply pipe 76 may be extended along the rear wall 24 and the lower wall 21 of the refrigerator 1 and then connected to the second dispenser 120 inside of the lower door 42 and 43 after passing through the lower hinge 16. According to the embodiment, since the second dispenser 120 is disposed in the first lower door 42, the third water supply pipe 76 may be provided inside of the first lower door 42.

The above mentioned configuration of the water supply system 70 is merely exemplary, but is not limited thereto. Alternatively, water supplied from the outside may be supplied to the first dispenser 110, the second dispenser 120 and the ice making unit 80 by using a water supply pipe that is configured differently from the embodiment.

The refrigerator 1 may include the first dispenser 110 provided in the first upper door 40 to provide water. A user may be supplied with the water by the first dispenser 110 without opening the upper door 40. According to the embodiment, the first dispenser 110 has been described to be disposed in the first upper door 40, but is not limited thereto. Thus, the first dispenser 110 may be disposed in the second upper door 41.

The first dispenser 110 may include a first water outlet 111 to discharge water, a first dispensing space 112 to accommodate a container in which the water is stored, a first container supporter 113 to support the container in which the water is stored, and an operation panel unit 101 to receive an operation command of the first dispenser 110 and the second dispenser 120 described later and to display an operation status.

The first water outlet 111 may be supplied with water by being connected to the second water supply pipe 75 that is diverged from the water supply valve 73. The second water supply pipe 75 may be extended along the rear wall 24 and the upper wall 20 of the refrigerator 1 and then extended to the inside of the first upper door 40 through the upper hinge 14. The second water supply pipe 75 extended to the inside of the first upper door 40 may be connected to the first water outlet 111 so that the user may be supplied with water via the first water outlet 111.

The first dispensing space 112 may be formed to be recessed in the front surface of the first upper door 40.

The first container supporter 113 may be provided in a lower end of the first dispensing space 112.

The operation panel unit 101 may be implemented by a touch display, and thus the user may input an operation command to the first dispenser 110 and the second dispenser 120 by the operation panel unit 101.

Due to the configuration, the user may be supplied with water. Further, since the first dispenser 110 is configured to supply only water, only the second water supply pipe 75 may be disposed inside of the first upper door 40. That is, a dispensing device configured to supply ice may be not additionally provided in the rear surface of the first upper door 40. Accordingly, according to the embodiment, the refrigerator 1 may secure a space for the auxiliary door 50 between the first upper door 40 and the body 10.

Since the first auxiliary door 50 is provided between the first upper door 40 and the body 10, and the second auxiliary door 51 is provided between the second upper door 41, in which the first dispenser 110 is not provided, and the body 10, the refrigerator 1 may provide the inside of the fresh food compartment 30 in a food show case type to a user. That is, the user may confirm the inside of the fresh food compartment 30 and insert and withdraw the food stored in the door guard 60 in a state in which the first upper door 40 and the second upper door 41 of the refrigerator 1 are opened although the first auxiliary door 50 and the second auxiliary door 51 are closed.

The refrigerator 1 may include the second dispenser 120 provided in the first lower door 42 to provide water and ice. A user may be supplied with the water and the ice by the second dispenser 120 without opening the first lower door 42. According to the embodiment, the second dispenser 120 has been described to be disposed in the first lower door 42, but is not limited thereto. Thus, the second dispenser 120 may be disposed in the second lower door 43. According to the embodiment, the second dispenser 120 is described to provide water and ice, but the second dispenser 120 may be configured to supply only ice by omitting the configuration for providing the water.

The second dispenser 120 may include a second water outlet 121 to discharge water, a second dispensing space 122 to accommodate a container in which the water is stored, a second container supporter 123 to support the container in which the water is stored, an ice outlet 124 to discharge ice, and a chute 125 to guide the ice discharged from the ice making unit 80 to the ice outlet 124.

The second water outlet 121 may be supplied with water by being connected to the third water supply pipe 76 that is diverged from the water supply valve 73. The third water supply pipe 76 may be extended along the rear wall 24 and the lower wall 21 of the refrigerator 1 and then extended to the inside of the first lower door 42 through the lower hinge 16. The third water supply pipe 76 extended to the inside of the first lower door 42 may be connected to the second water outlet 121 so that the user may be supplied with water via the second water outlet 121.

The second dispensing space 122 may be formed to be recessed in the front surface of the first lower door 42.

The second container supporter 123 may be provided in a lower end of the second dispensing space 122.

The ice outlet 124 may be formed on a position higher than or the same as a height of the bottom of the ice bucket 82. The ice outlet 124 may be connected to the chute 125 so that the ice discharged from the ice making unit 80 may be provided to the user.

The refrigerator 1 may include the ice making unit 80. The ice making unit 80 is illustrated to be disposed in the first freezer compartment 31 to correspond to the first lower door 42 in which the second dispenser 120 is provided, but is not limited thereto. Thus, when the second dispenser 120 is provided in the second lower door 43, the ice making unit 80 may be disposed in the second freezer compartment 32.

The ice making unit 80 may include an ice maker 81 to generate ice and an ice bucket 82 to store the ice generated by the ice maker 81. The ice maker 81 may include an ice tray to store water, and an ejector to separate the ice generated in the ice tray.

The ice maker 81 may generate ice in an indirect cooling method in which water is frozen by cold air of the first freezer compartment 31 or in a direct cooling method in which water is frozen by directly receiving cooling energy by a refrigerant pipe that makes contact with the ice tray.

In the ice bucket 82, a transfer device to deliver ice stored in the ice bucket 82 may be provided. The transfer device may include an auger 83 having a spiral shape and a driving device to drive the auger 83. When the auger 83 is rotated, the ice stored in the ice bucket 82 may be transferred to the front side.

An ice discharging unit 84 may be formed in the front side of the ice bucket 82 to discharge ice to the outside, and the ice discharged via the ice discharging unit 84 may be guided to the chute 125 of the second dispenser 120.

The ice bucket 82 may include an inclined part inclined upwardly to the front side, and the auger 83 may be disposed such that a rotational axis thereof is inclined. Due to the structure, the ice discharging unit 84 may be placed higher than the bottom surface of the ice bucket 82. That is, the ice stored in the ice bucket 82 may be moved slightly upward and then fallen when discharged.

An opening and closing device (not shown) may be provided in the ice discharging unit 84 to prevent cold air from being leaked via the ice discharging unit 84 when the first lower door 42 is opened. The opening and closing device may be operated in conjunction with a motion of opening and closing of the first lower door 42. For example, the opening and closing device may be movable upward and downward, and thus when the first lower door 42 is closed, the opening and closing device may be moved downward to open the ice discharging unit 84 and when the first lower door 42 is opened, the opening and closing device may be moved upward to close the ice discharging unit 84.

As mentioned above, since the second dispenser 120 is provided in the first lower door 42 and the ice making unit 80 is provided in the first freezer compartment 31, the auxiliary door 50 and 51 may be provided between the upper door 40 and 41, and the body 10 so that the refrigerator 1 according to the embodiment may provide the inside of the fresh food compartment 30 in a food show case type to a user.

Accordingly, the refrigerator 1 according to the embodiment may allow a user to insert and withdraw the food in a variety of ways according to the user's needs. When inserting and withdrawing the food stored in the plurality of door guards 60, the user may open only the upper door 40 and 41 and thus the leakage of the cold air may be minimized.

Since the second dispenser 120 and the ice making unit 80 for providing ice are installed in the first lower door 42 and the first freezer compartment 31, respectively, the space utilization of the upper door 40 and 41, and the fresh food compartment 30 may be maximized.

The second dispenser 120 may further include a shutter 126 configured to close the second dispenser 120 from the outside when the second dispenser 120 is not use. The shutter 126 may selectively expose the second dispenser 120. The shutter 126 may be disposed on the same plane as the first lower door 42 so that the shutter 126 is looked like a part of the first lower door 42 when the second dispenser 120 is closed. The shutter 126 may be formed to correspond to the size of the second dispensing space 122.

Since a lower end part 127 of the shutter 126 is hinge-coupled to the first lower door 42, the shutter 126 may be rotatably moved with respect to the first lower door 42 to selectively expose the second dispenser 120 to the outside. That is, the shutter 126 may be opened and closed in a home bar type. The shutter 126 may be manually opened and closed, but alternatively the shutter 126 may be automatically opened and closed by using an additional driving device although not shown in the drawings.

When the shutter 126 is configured to be automatically opened and closed, the first lower door 42 may include a detection sensor 128, e.g. a proximity sensor to drive the shutter 126 by determining whether the user is closed or not, and a voice recognition sensor to driver the shutter 126 by using the user's voice. Accordingly, the shutter 126 may be selectively opened and closed according to a command detected by the detection sensor 128. Otherwise, although not shown in the drawings, the first lower door 42 may include a button configured to input a command for driving the shutter 126.

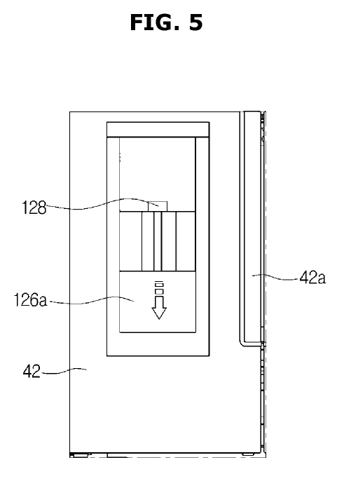

Referring to FIG. 5, a shutter 126a may be moved up and down in a sliding manner. Particularly, when the detection sensor 128 provided in the first lower door 42 detects a user, the shutter 126a may expose the second dispenser 120 to the outside while being moved to the lower side in the sliding manner by a driving device (not shown). That is, the shutter 126a may allow the second dispenser 120 to be an available state. In addition, although not shown in the drawings, a handle (not shown) may be provided in the shutter 126a so that a user may manually move up and down the shutter 126a in the sliding manner.

Therefore, since the second dispenser 120 is exposed to the outside only when it is required to use the second dispenser 120, it may be prevented that the second dispenser 120 is contaminated by foreign materials. In addition, according to the embodiment, the second dispenser 120 may be provided in the first lower door 42 and thus the second dispenser 120 may be placed in a relatively low height. However, when a small child accesses to the second dispenser 120, the small child may not easily use the second dispenser 120 due to the shutter 126a.

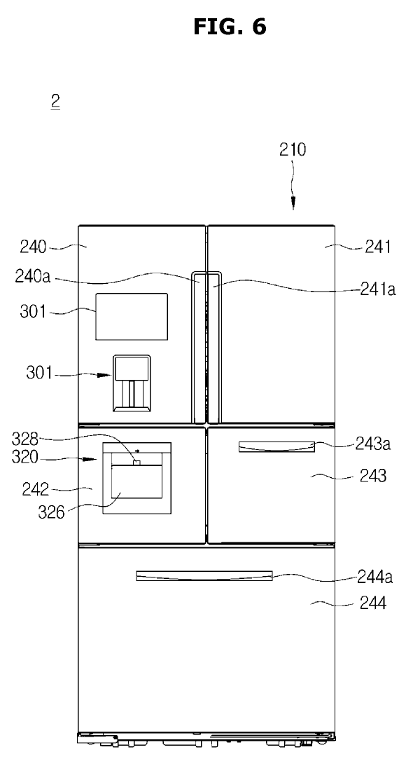

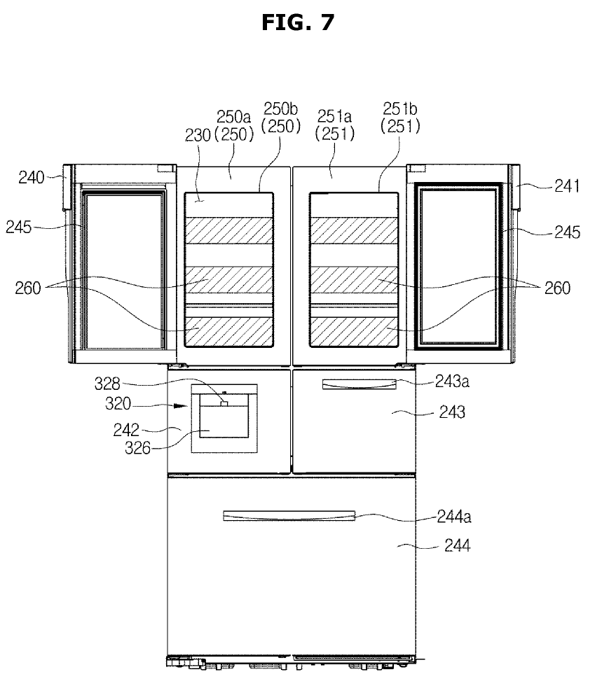

FIG. 6 is a view illustrating another example of the refrigerator 1 shown in FIG. 1. FIG. 7 is a view illustrating a state in which an upper door 240 and 241 of a refrigerator 2 shown in FIG. 6 is opened.

A refrigerator 2 according to another embodiment of the present disclosure will be described with reference to FIGS. 6 and 7. A description of the same parts as the above mentioned embodiment will be omitted.

According to another embodiment, a storage compartment may include an upper compartment 230, a center compartment (not shown), and a lower compartment (not shown). The upper compartment 230 may include a fresh food compartment 230. The center compartment may include an ice making compartment and an auxiliary storage compartment. The lower compartment may include a freezer compartment.

The upper compartment 230 may be opened and closed by an upper door 240 and 241 and an auxiliary door 250 and 251. The upper door 240 and 241 may include a first upper door 240 and a second upper door 241. The upper door 240 and 241 may include a sealing member 245. The auxiliary door 250 and 251 may include a first auxiliary door 250 and a second auxiliary door 251. The auxiliary door 250 and 251 may include an auxiliary door case 250a and 251a, and an opening 250b and 251b, respectively. A door guard 260 may be provided on each of the auxiliary door 250 and 251.

Therefore, the refrigerator 2 according to the embodiment may provide the fresh food compartment 230 in the food show case type to a user in a state in which the upper door 240 and 241 is opened and the auxiliary door 250 and 251 is closed. That is, the user may confirm the inside of the upper compartment 230 without completely opening the upper door 240 and 241 and the auxiliary door 250 and 251. Further, the user may insert and withdraw food stored in the door guard 260 provided in the auxiliary door 250 and 251, via the opening 250b and 251b.

A first dispenser 310 configured to provide water may be provided in the first upper door 240 of the fresh food compartment 230. The first dispenser 310 may be supplied with water via a second water supply pipe (not shown), as illustrated in FIG. 4. In addition, the first upper door 240 may include an operation panel 301 configured to receive an input of a command for operation the first dispenser 310 and a second dispenser 320.

The second dispenser 320 configured to supply water and ice may be provided on an ice making compartment door 242. An ice maker may be provided inside of the ice making compartment. The ice maker may be supplied with water via a fourth water supply pipe (not shown) provided inside of a body 210, as illustrated in FIG. 4. Unlike the embodiment shown in FIG. 4, the second dispenser 320 may be supplied with water via a third water supply pipe (not shown) provided inside of the body 210. However, the configuration of the water supply pipe is not limited thereto.

The ice making compartment door 242 may include a shutter 326 configured to selectively open and close the second dispenser 320 so that the second dispenser 320 is not exposed to the outside when the second dispenser 320 is not use. The shutter 326 may be operated by a detection sensor 328.

The auxiliary storage compartment may be opened and closed by a middle door 243. The auxiliary storage compartment may include a fresh food compartment or a freezer compartment. Further, the auxiliary storage compartment may include a temperature convertible compartment. The middle door 243 may be configured to be opened and closed in a sliding manner. The middle door 243 may include a handle 243a so that the user opens and closes the middle door 243 by holing the handle 243a.

The freezer compartment may be opened and closed by a lower door 244. The lower door 244 may be configured to be opened and closed in a sliding manner. The lower door 244 may include a handle 244a so that the user opens and closes the lower door 244 by holing the handle 244a.

As mentioned above, in the refrigerator 2 according to the embodiment, the ice maker 80 may be disposed in the first freezer compartment 31 or the ice making compartment, the second dispenser 120 and 320 configured to provide ice may be provided in the lower door 42 and 244, the first dispenser 110 and 310 configured to provide water may be provided in the upper door 40 and 240, and the upper door 40, 41, 240 and 241 may be provided in a double door type. Accordingly, the refrigerator 2 may provide entire of the fresh food compartment 30 in the food show case type to a user.

As is apparent from the above description, according to the proposed refrigerator, since the ice maker is disposed in the freezer compartment, a storage space of the fresh food compartment may be increased.

According to the proposed refrigerator, since the dispenser configured to provide ice is provided in the freezer compartment door, the fresh food compartment door may be provided in a double door and thus a user may confirm, and insert and withdraw food stored inside of the fresh food compartment without completely opening the fresh food compartment door.

Further, since the refrigerator is provided with the shutter configured to selectively expose the dispenser so as to prevent the dispenser from being exposed to the outside, it may be possible to prevent the dispenser from being contaminated due to the exposure to the outside and thus the malfunction caused by the exposure may be prevented.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A refrigerator comprising:
a body;
a fresh food compartment provided in an upper portion of the body;
a freezer compartment provided in a lower portion of the body;
an upper door configured to open or close the fresh food compartment;
a lower door configured to open or close the freezer compartment;
a first dispenser provided in the upper door and configured to provide water; and
a second dispenser provided in the lower door and configured to provide ice.

2. The refrigerator of claim 1 further comprising:
an ice making unit connected to the second dispenser to generate ice, wherein the ice making unit is disposed inside of the freezer compartment.

3. The refrigerator of claim 2 further comprising:
a filter disposed inside of the body to purify water supplied from a water source; and
a water supply valve configured to selectively supply water, which is purified by passing through the filter, to one of the first dispenser, the second dispenser and the ice making unit.

4. The refrigerator of claim 3 further comprising:
a storage tank provided on a flow path in which water, which is purified by passing through the filter, is supplied to the first dispenser and the second dispenser, and provided on the flow path between the filter and the water supply valve.

5. The refrigerator of claim 3 wherein
a flow path connecting the ice making compartment and the water supply valve is disposed inside of the body.

6. The refrigerator of claim 3 wherein
a flow path connecting the water supply valve and the first dispenser is configured to pass through an upper hinge corresponding to a rotational axis of the upper door, and a flow path connecting the water supply valve and the second dispenser is configured to pass through a lower hinge corresponding to a rotational axis of the lower door.

7. The refrigerator of claim 1 wherein
the lower door comprises a shutter configured to selectively expose the second dispenser.

8. The refrigerator of claim 7 wherein
the lower door comprises a detection sensor disposed adjacent to the second dispenser to detect a command of a user related to whether to open or close the shutter, wherein the shutter is configured to be selectively opened or closed by the command detected by the detection sensor.

9. The refrigerator of claim 8 wherein
the detection sensor comprises at least one of a proximity sensor and a voice recognition sensor.

10. The refrigerator of claim 7 wherein
one end portion of the shutter is hinge-coupled to the lower door so that the shutter is opened or closed while being rotatably moved with respect to the lower door.

11. The refrigerator of claim 7 wherein
the shutter is configured to be opened or closed in a sliding manner with respect to the lower door.

12. The refrigerator of claim 1 wherein
the upper door comprises a first upper door and a second upper door, a first auxiliary door configured to be rotated independently from the first upper door is provided between the first upper door and the fresh food compartment and a second auxiliary door configured to be rotated independently from the second upper door is provided between the second upper door and the fresh food compartment.

13. The refrigerator of claim 12 wherein
at least one of the first auxiliary door and the second auxiliary door comprises a door guard and an opening configured to allow a user to access to the fresh food compartment when the upper door is opened.

14. The refrigerator of claim 13 wherein
the door guard comprises a transparent material to confirm food stored in the fresh food compartment.

15. The refrigerator of claim 1 wherein
the second dispenser is configured to provide ice and water.

16. A refrigerator comprising:
a body;
a fresh food compartment provided in an upper portion of the body;
an ice making compartment provided in a lower side of the fresh food compartment;
a freezer compartment provided in a lower side of the ice making compartment;
an upper door configured to open or close the fresh food compartment;
an ice making compartment door configured to open or close the ice making compartment;
a lower door configured to open or close the freezer compartment;
a first dispenser provided in the upper door and configured to provide water; and
a second dispenser provided in the ice making compartment door and configured to provide ice.

17. The refrigerator of claim 16 wherein
an ice maker configured to generate ice and an ice bucket configured to store the ice generated by the ice maker are provided inside of the ice making compartment.

18. The refrigerator of claim 16 wherein
the ice making compartment door comprises a shutter configured to selectively expose the second dispenser.

19. A refrigerator comprising:
a body;
a fresh food compartment provided in an upper portion of the body;
a freezer compartment provided in a lower portion of the body;
an upper door configured to open or close the fresh food compartment and arranged side by side in a left and right direction of the fresh food compartment;
a lower door configured to open or close the freezer compartment;
a first dispenser provided in the upper door and configured to provide water; and
an auxiliary door provided between the upper door and the fresh food compartment and configured to be rotated independently from the upper door.

20. The refrigerator of claim 19 wherein
the auxiliary door comprises a plurality of door guards configured by comprising a transparent material, wherein the plurality of door guards is apart from each other to communicate the fresh food compartment with the outside when the upper door is opened.
